(19) United States
(12) Patent Application Publication
(10) Pub. No.: US 2009/0300524 A1
(43) Pub. Date: Dec. 3, 2009

(54) AUTOMATICALLY ASSIGNING DATA BINDINGS IN VISUAL DESIGNERS

(75) Inventors: Jason D. Carlson, Redmond, WA (US); Brian L. Welcker, Seattle, WA (US); Carolyn K. Chau, Carnation, WA (US); Brian J. Hartman, Bellevue, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/130,270

(22) Filed: May 30, 2008

(51) Int. Cl. G06F 3/048

(52) U.S. Cl. 715/763

(57) ABSTRACT

Various technologies and techniques are disclosed for automatically assigning data bindings to data sources and data sets in the design surface of visual designers. A user selection is received to insert a data element into a data region on a design surface. When there is just one data source and one data set defined in the design surface, a list of fields from the one data set is displayed in a user-selectable list, and the data set is automatically assigned to the data element based upon the selected field. As the user interacts with the design surface to insert additional data elements, the additional data elements are automatically assigned to the previously-utilized data source and data set, and a list of fields from the automatically assigned data set is displayed in a user-selectable list. This saves the user from having to select a desired data set and desired data source.

### BACKGROUND

Visual designers, such as report designers, can be used to bind a visual representation of data with the underlying structure of the data. Visual designers tend to deal with a lot of data, including data sets, fields, and so on. Users typically create queries or other meaningful views of the data, and can then retrieve certain fields for use in the visual representation, such as a report. When creating the visual representations of the data, users are typically presented with multiple data sets that can each have several data fields. It can be cumbersome for the user to drag and drop fields from a data pane or select the desired fields manually for inclusion in the visual representation.

### SUMMARY

Various technologies and techniques are disclosed for automatically assigning data bindings to data sources and data sets in the design surface of visual designers, such as report designers. A user selection is received to insert a data element into a data region on a design surface of a visual designer. In response to the user selection to insert the data element, when there is just one data source and one data set defined in the design surface, a list of fields from the one data set is displayed in a user-selectable list, such as a smart tag, and the one data set is automatically assigned to the data element based upon the user's selection of a field in the list.

In one implementation, as the user interacts with the design surface to insert additional data elements, the additional data elements are automatically assigned to the previously-utilized data source and data set, and a list of fields from the automatically assigned data set is displayed in a user-selectable list. This saves the user from having to select a desired data set and a desired data source.

This Summary was provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a diagrammatic view of a visual designer of one implementation which automatically assigns data sources and/or data sets to data elements in a data region.

FIG. 2 is a process flow diagram for one implementation illustrating the stages involved in automatically assigning data sources and data sets to data elements in a data region of a design surface at design time.

FIG. 3 is a simulated screen for one implementation that illustrates creating a new data source when inserting a new data element.

FIG. 4 is a simulated screen for one implementation that illustrates automatically assigning a data element in a data region to a data source and a data set and displaying the fields from the data set in a user-selectable field list.

FIG. 5 is a simulated screen for one implementation that illustrates a hierarchical set of lists for enabling the user to easily navigate among different data sources and data sets to select desired fields to insert for a data region.

FIG. 6 is a simulated screen for one implementation that illustrates displaying an option to a user to create a new data set.

FIG. 7 is a simulated screen for one implementation that illustrates a list of fields available for a selected data set that can be inserted into a data region.

FIG. 8 is a process flow diagram for one implementation that illustrates the stages involved in handling errors that are discovered with data sets as the user navigates through the hierarchical lists.

FIG. 9 is a simulated screen for one implementation that illustrates an error message being displayed when there are no fields assigned to a selected data set.

FIG. 10 is a diagrammatic view of a computer system of one implementation.

### DETAILED DESCRIPTION

The technologies and techniques herein may be described in the general context as an application that automatically assigns data sources and data sets in visual designers, but the technologies and techniques also serve other purposes in addition to these. In one implementation, one or more of the techniques described herein can be implemented as features within a software development program such as MICROSOFT® Visual Studio, or from any other type of program or service that enables the creation of reports, forms, or other visual representation of underlying data sources.

In one implementation, smart tags are utilized to simplify the work flow for users of visual designers to enhance their experience when creating reports, forms, or other visual representations of data sources. The user is provided with easy access to the list of fields in a given data set from within a data region of the design surface, without having to search for a list of fields. These concepts are described in detail in the figures that follow.

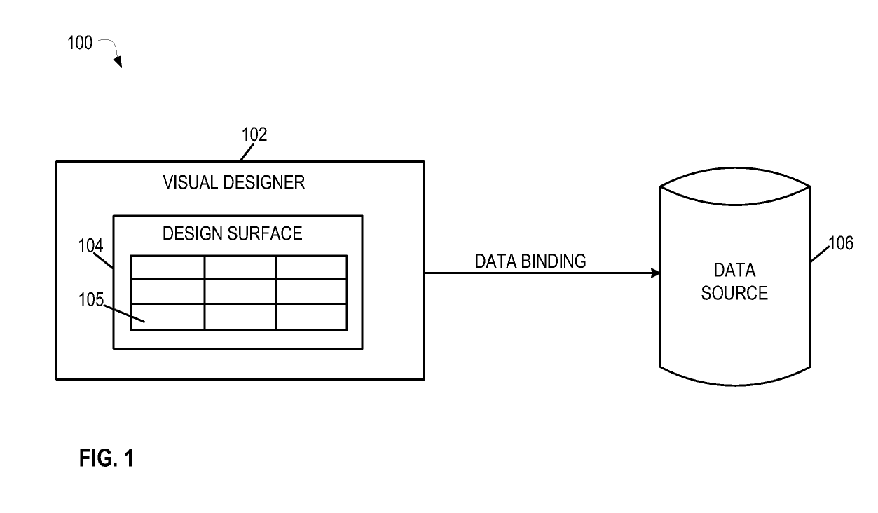

FIG. 1 is a diagrammatic view of a visual designer system 100 of one implementation which automatically assigns data sources and/or data sets to data elements within a data region. A visual designer 102 contains a design surface 104. The design surface 104 contains the visible area that the user can utilize for accessing various features of the visual designer 102. The design surface 104 contains one or more data region(s) 105. A “data region” is an area of a design surface where the user places the fields or other data elements to be included in a given visual representation (report, form, etc.) that is being designed. For example, the data region(s) 105 can include a table, matrix, or chart of fields to include in a report. The term “data element” as used herein is meant to include a field from a data set or another piece of data that can be included in a visual representation. A visual representation is a report, form, or other visual representation of data in data source(s) 106 that are being designed in a visual designer. Data elements within the data region(s) 105 are then assigned (through data binding) to underlying data source(s) 106. A user of the visual designer 102 can interact with the data region(s) 105 to navigate easily-accessible lists of available data sources, data sets, and fields within those data sets. In other words, the user can select the desired data elements for inclusion in the visual representation by navigating through the options presented in the data region(s) 105.

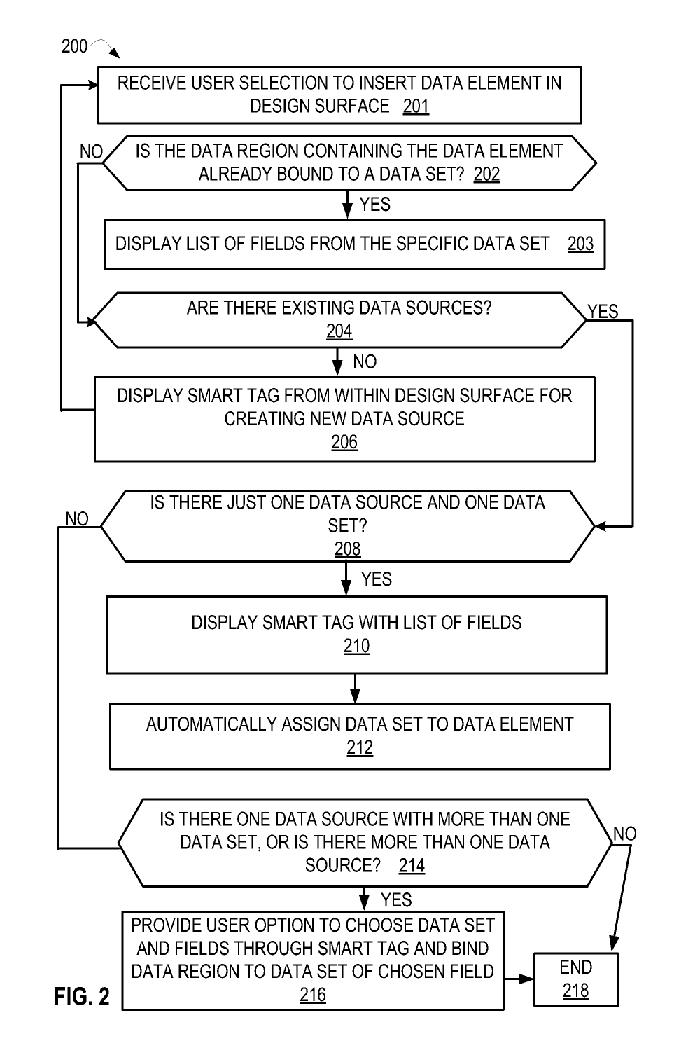

In one implementation, this navigation is presented to the user in the data region(s) 105 through smart tags. The term “smart tag” as used herein is meant to include a context-sensitive list of one or more options that can be selected by the user. In another implementation, any type of user-selectable lists or options can be used to enable the user to easily select and navigate through the available options to assign data elements in the data region(s) 105 to the underlying data source(s) 106. Using some of the techniques described herein, including FIG. 2, the number of selections the user needs to make in order to assign data element in data region(s) 105 to data source(s) 106 is minimized through automatic assignment of data sources and/or data sets. Alternatively or additionally, the number of selections can also be minimized by receiving an initial selection from a user for a data source and/or a data set. Then, as the user interacts with the design surface to insert additional data elements, the additional data elements are automatically assigned to the previously chosen data source and data set to save additional selection steps for the user. FIGS. 2-9 provide several examples to further illustrate these concepts.

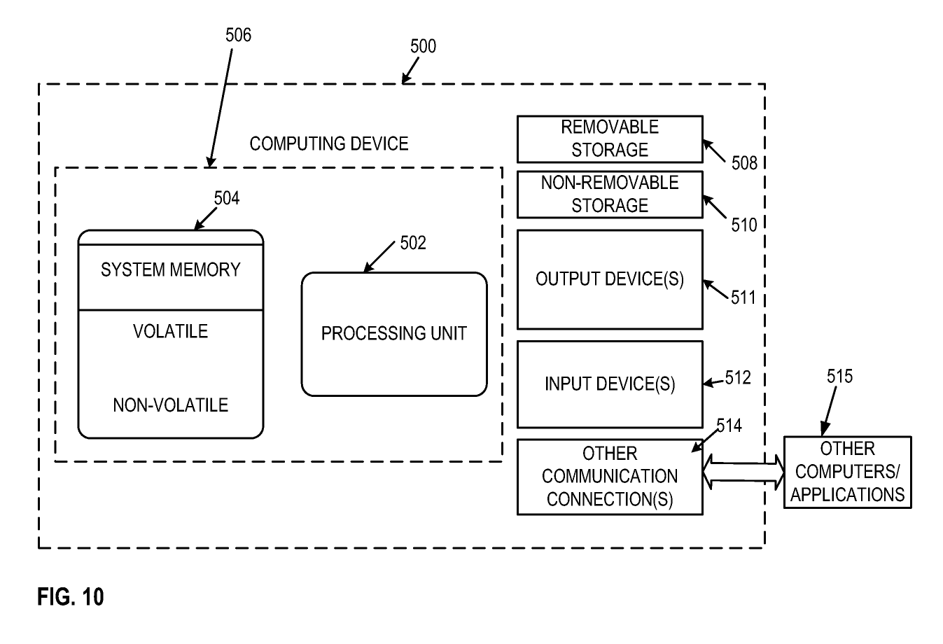

Turning now to FIGS. 2-9, the stages for implementing one or more implementations of visual designer system 100 are described in further detail. In some implementations, the processes of FIG. 2-9 are at least partially implemented in the operating logic of computing device 500 (of FIG. 10).

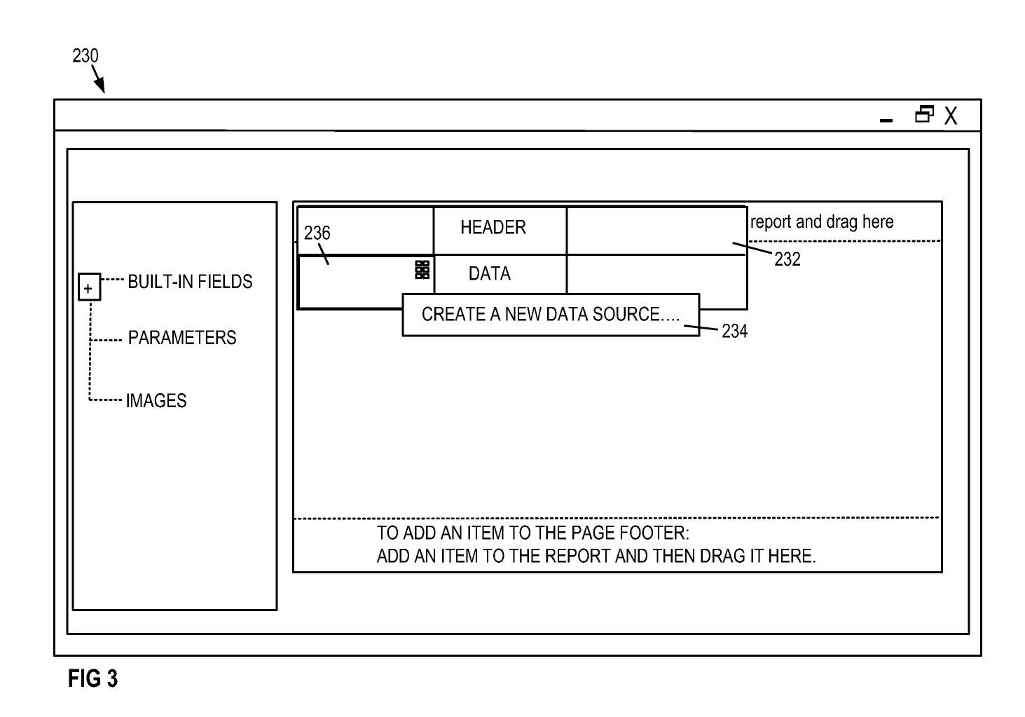

FIG. 2 is a process flow diagram for one implementation illustrating the stages involved in automatically assigning data sources and data sets to data elements in a data region of a design surface at design time. User selection is received to insert a data element into a data region of the design surface (stage 201). If the data region that contains the data element is already bound to a data set (decision point 202), then a list of fields is displayed from the specific data set to which the data element is already bound (stage 203). If the data region that contains the data element is not already bound to a data set (decision point 202), and when no data sources already exist for the visual representation being designed (decision point 204), then a smart tag or other option is presented to the user from within the design surface to allow a new data source to be created (stage 206). The creation of a new data source is illustrated in the simulated screen of FIG. 3, which will be discussed later.

When there is just one data source and one data set in existence for the visual representation being designed (decision point 208), then a smart tag or other user-selectable field list is displayed to enable the user to select a desired field from that data set to use for the data element being inserted (stage 210). The one data set that exists is automatically assigned (data bound) to the data element being inserted (stage 212). In other words, once the user selects a desired field from the smart tag or other user-selectable field list, the data region is bound to the data set of the chosen field (stage 212).

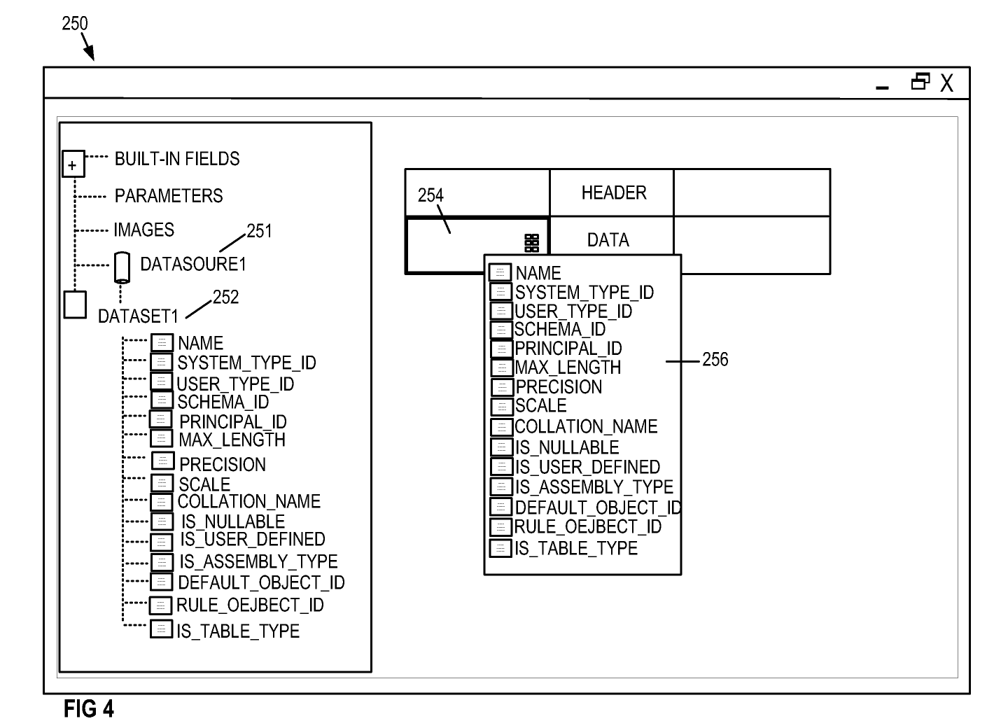

When there is one data source with more than one data set, or when there is more than one data source (decision point 214), then the user is provided with an option to choose the data source (when more than one present), data set (when more than one present) and fields through a smart tag or other user-selectable option or list (stage 216). Once the user selects a desired field from the smart tag or other user-selectable option, then the data region is bound to the data set of the chosen field (stage 216). The simulated screens in FIGS. 4-7 provide several examples of how the level of options presented to the user can vary depending on the number of data source and data sets currently defined for the visual representation. In other words, automatic assignments are made where possible to reduce the number of selections the user needs to make in order to specify the desired field to be assigned to the data element being inserted. Some example screens will now be described in FIGS. 3-7 to further illustrate these concepts.

FIG. 3 is a simulated screen 230 for one implementation that illustrates creating a new data source when inserting a new data element into a data region. As described in FIG. 2 (stage 206), when the user selects an option 236 to insert a new data element into a data region 232 on a design surface, if there are no data sources already defined, then the user is presented with an option to create a new data source 234. In the example shown in FIG. 3, the user selects an option 236 to insert a new data element by simply clicking or otherwise selecting data region 232. The option to create the new data source 234 is then shown in a smart tag or other option within the context of the data region 232 that the user is working in.

FIG. 4 is a simulated screen 250 for one implementation that illustrates automatically assigning a data element 254 in a data region to a data source 251 and a data set 252, and then displaying the fields from the data set in a user-selectable field list 256. As described in FIG. 2 (step 208), when there is only one data source and one data set defined for the visual representation, then that data source and data set can be automatically assigned to the data element 254 being inserted into the data region. This allows the user to see a list of fields available for the data element 254 without having to first select a data source 251 and data set 252. The user can then select a desired field from the user-selectable field list 256, and that selected field is then assigned to the data element being inserted to create the data binding.

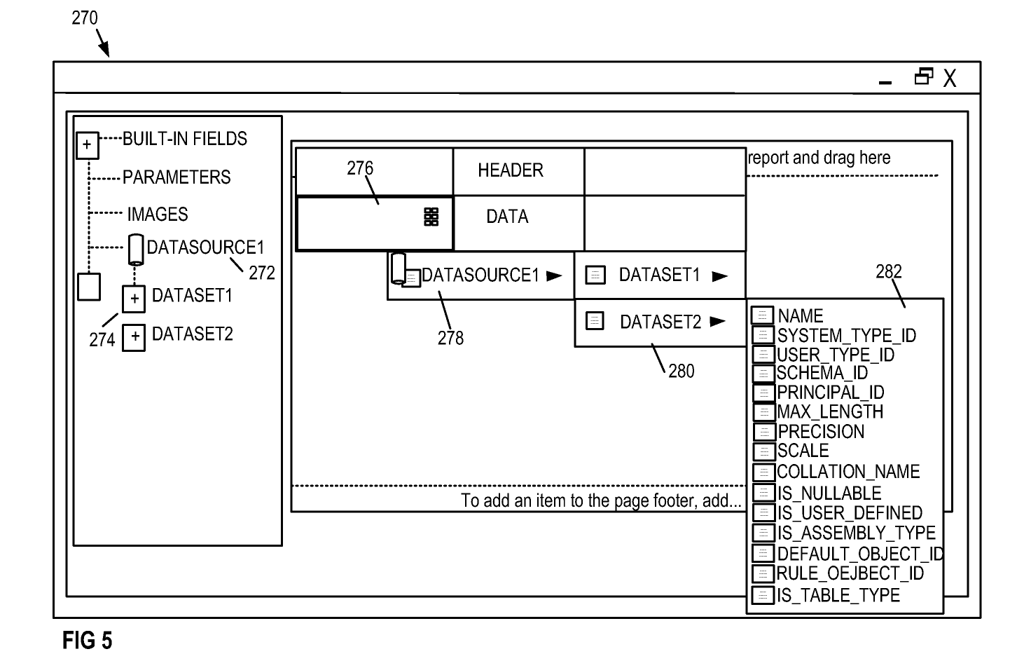

FIG. 5 is a simulated screen 270 for one implementation that illustrates a hierarchical set of lists for enabling the user to easily navigate among different data sources and data sets to select desired fields to insert for a data region. In the example shown, since there are multiple data sets 274, the user is presented with an option to select a data source 278 and a data set 280 when selecting the data region 276 to insert a new data element. The user can then see a list of the fields 282 for the selected data set 280 in a user-selectable field list. Upon selecting a desired field from the list of fields 282, the selected field is then assigned to the data element. In other words, the selected field is assigned as the data element that is then bound to the underlying data source.

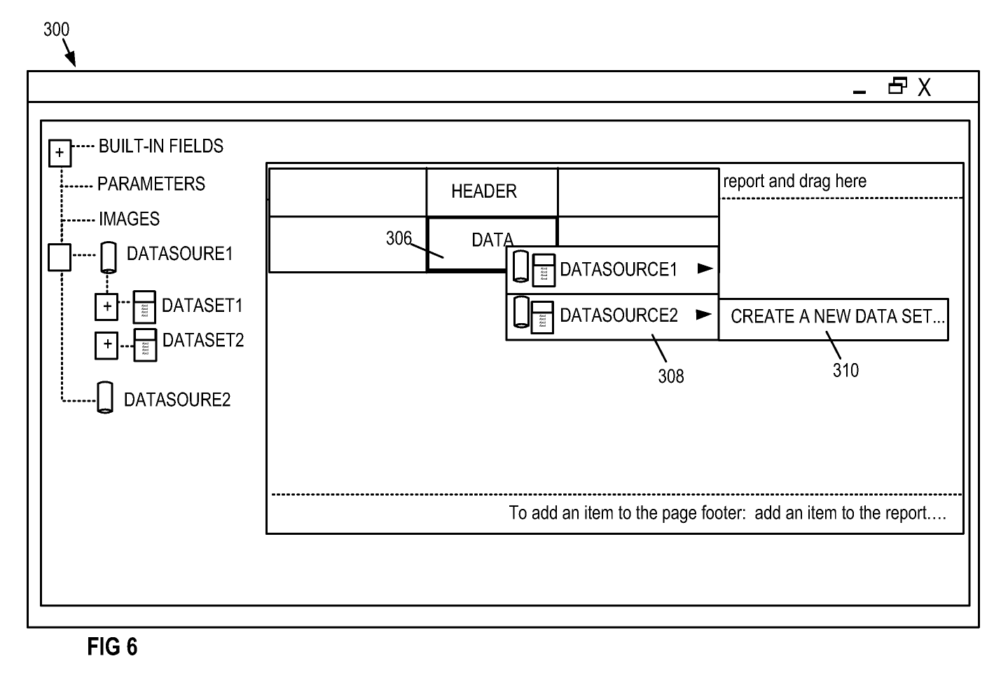

FIG. 6 is a simulated screen 300 for one implementation that illustrates displaying an option to a user to create a new data set. When the user selects an option to insert a new data element 306 into a data region, and there are no data sets yet defined for a selected data source 308, the user is presented with an option to create a new data set 310. A separate window or other options can then be displayed to enable the user to finish creating the data set.

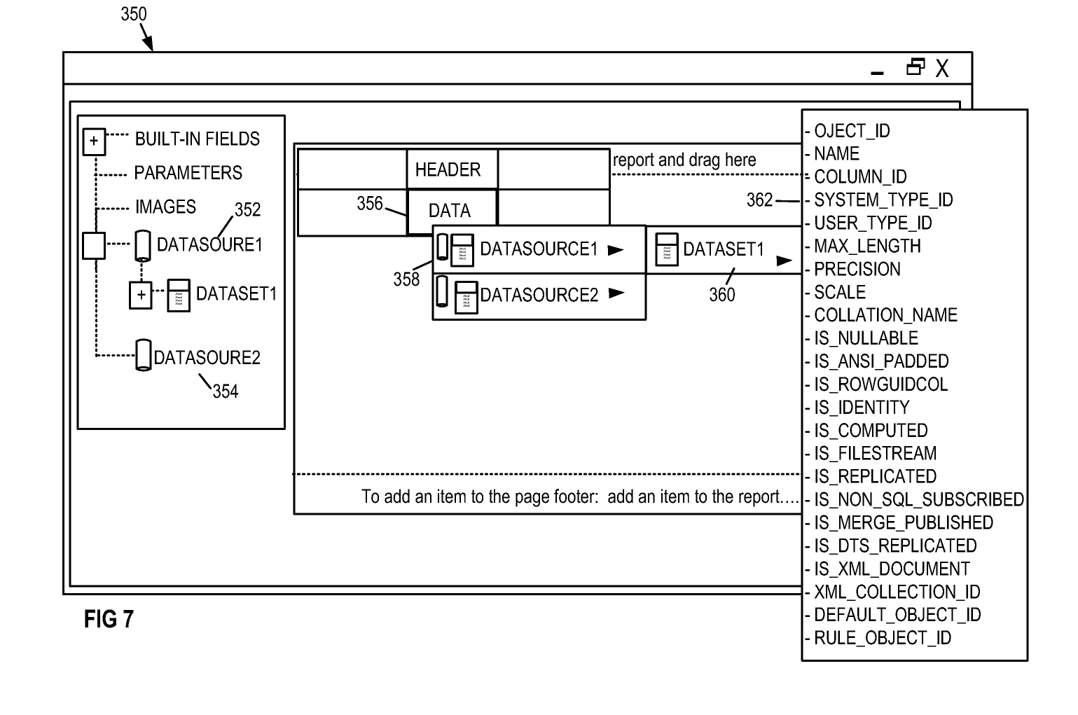

FIG. 7 is a simulated screen 350 for one implementation that illustrates a list of fields available for a selected data set that can be inserted into a data region. In the example shown, there are multiple data sources 352 and 354 that have been defined for the current visual representation. Thus, when selecting an option to insert a new data element 356, the available data sources are displayed, and when a particular data source 358 is selected, the data set(s) (in this case dataset 360) are shown. Upon selecting dataset 360, the user is shown a list of fields 362 contained in dataset 360. Upon selecting a particular field from the list of fields 362, that field gets assigned as the data element and bound to the specified data source.

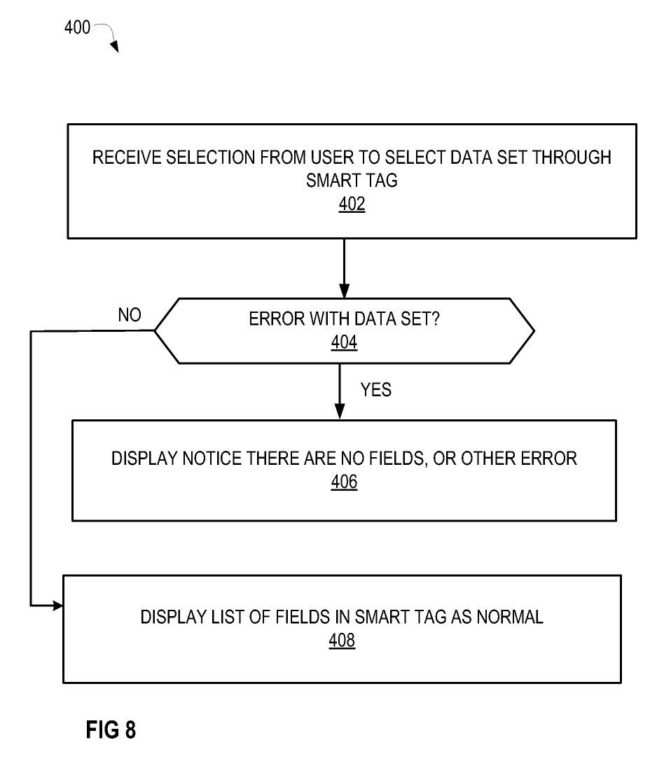

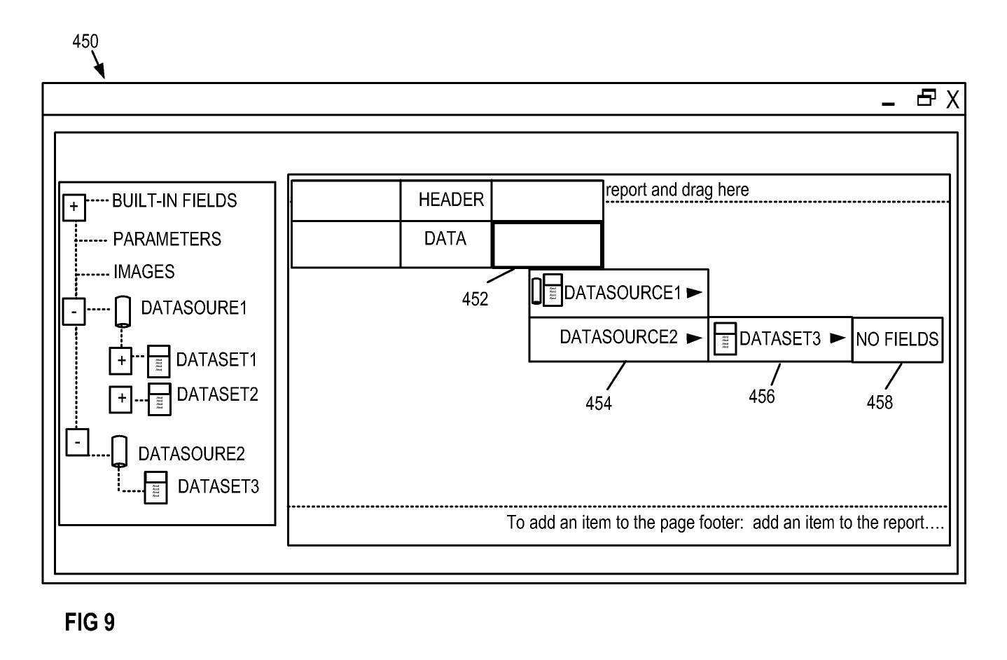

FIG. 8 is a process flow diagram 400 for one implementation that illustrates the stages involved in handling errors that are discovered with data sets as the user navigates through the hierarchical lists. A selection is received from a user to select a data set through a smart tag or other option (stage 402). If an error or other problem is discovered with the data set (decision point 404), then an appropriate error description is displayed (stage 406). For example, if the error is due to the fact that there are no fields for that data set, then the error message can say something like “No Fields Defined”. An example of this is shown in FIG. 9. In one implementation, upon selecting the error message, a separate window or option can be launched to enable the user to correct the error. If there is not an error with the data set being selected (decision point 404), then the list of fields is displayed in the smart tag or other user-selectable field list as normal (stage 408).

FIG. 9 is a simulated screen 450 for one implementation that illustrates an error message being displayed when there are no fields assigned to a selected data set. In this example, the user has selected an option to insert a new data element 452, and the list of available data sources is then shown. Upon selecting a desired data source 454, then the data set 456 is shown as part of the selected data source 454. Since there are no fields yet defined for dataset 456, then an error message 458 is displayed to indicate there are no fields.

As shown in FIG. 10, an exemplary computer system to use for implementing one or more parts of the system includes a computing device, such as computing device 500. In its most basic configuration, computing device 500 typically includes at least one processing unit 502 and memory 504. Depending on the exact configuration and type of computing device, memory 504 may be volatile (such as RAM), non-volatile (such as ROM, flash memory, etc.) or some combination of the two. This most basic configuration is illustrated in FIG. 10 by dashed line 506.

Additionally, device 500 may also have additional features/functionality. For example, device 500 may also include additional storage (removable and/or non-removable) including, but not limited to, magnetic or optical disks or tape. Such additional storage is illustrated in FIG. 10 by removable storage 508 and non-removable storage 510. Computer storage media includes volatile and nonvolatile, removable and non-removable media implemented in any method or technology for storage of information such as computer readable instructions, data structures, program modules or other data. Memory 504, removable storage 508 and non-removable storage 510 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by device 500. Any such computer storage media may be part of device 500.

Computing device 500 includes one or more communication connections 514 that allow computing device 500 to communicate with other computers/applications 515. Device 500 may also have input device(s) 512 such as keyboard, mouse, pen, voice input device, touch input device, etc. Output device(s) 511 such as a display, speakers, printer, etc. may also be included. These devices are well known in the art and need not be discussed at length here.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. All equivalents, changes, and modifications that come within the spirit of the implementations as described herein and/or by the following claims are desired to be protected.

For example, a person of ordinary skill in the computer software art will recognize that the examples discussed herein could be organized differently on one or more computers to include fewer or additional options or features than as portrayed in the examples.

What is claimed is:

1. A method for automatically assigning data sources and data sets to data elements in a data regions of a design surface at design time comprising the steps of:
receiving a user selection to insert a data element into a data region on a design surface of a visual designer; and
in response to the user selection to insert the data element, when there is just one data source and one data set defined in the design surface, displaying a list of fields from the one data set in a user-selectable list, and automatically assigning the one data set to the data element after a user selects one of the fields from the list of fields.

2. The method of claim 1, wherein the user-selectable list is a smart tag.

3. The method of claim 1, further comprising the steps of:
in response to the user selection to insert the data element, when there are no existing data sources defined on the design surface, displaying an option for creating a new data source.

4. The method of claim 3, wherein the option for creating the new data source is displayed as a smart tag.

5. The method of claim 1, further comprising the steps of:
in response to the user selection to insert the data element, when the one data source has more than one data set, then displaying a list of available data sets.

6. The method of claim 5, wherein upon receiving user selection of one of the available data sets, further displaying a list of available fields in the selected one of the available data sets.

7. The method of claim 1, further comprising the steps of:
in response to the user selection to insert the data element, when there is more than one data source, then displaying a list of available data sources.

8. The method of claim 7, wherein upon receiving user selection of one of the available data sources, further displaying a list of available data sets in the selected one of the available data sources.

9. The method of claim 8, wherein upon receiving user selection of one of the available data sets in the selected one of the available data sources, further displaying a list of available fields in the selected one of the available data sets.

10. The method of claim 1, further comprising the steps of:
in response to the user selection to insert the data element, when there is an error with the one data set, displaying an error description in the user-selectable list instead of the list of fields.

11. A method for automatically assigning data sources and data sets in a design surface based upon prior user selections comprising the steps of:
receiving an initial selection of a data source and a data set to assign to data elements being inserted into data regions of a design surface; and
as a user interacts with the design surface to insert additional data elements, automatically assigning the additional data elements to the data source and the data set and then displaying a list of fields from the automatically assigned data set in a user-selectable list, thereby saving the user from having to select a desired data set and a desired data source.

12. The method of claim 11, wherein the user-selectable list is a smart tag.

13. The method of claim 11, wherein the initial selection of the data source and the data set to assign to data elements is made by the user.

14. The method of claim 11, wherein the design surface is a report designer.

15. The method of claim 11, wherein the initial selection of the data source and the data set to assign to data elements is made programmatically when there is just one data source and one data set defined on the design surface.

16. The method of claim 11, wherein the user can quickly add a plurality of fields from the data set to the design surface.

17. A computer-readable medium having computer-executable instructions for causing a computer to perform steps comprising:
receiving a selection from a user to insert a data element into a data region on a design surface of a visual designer;
in response to the selection to insert the data element, when there is just one data source and one data set defined in the design surface, automatically assigning the one data set to the data element, and displaying a list of fields from the one data set in a user-selectable field list;
in response to the selection to insert the data element, when there are no existing data sources defined on the design surface, displaying an option for creating a new data source;
in response to the selection to insert the data element, when there is more than one data source, then displaying a list of available data sources; and
in response to the selection to insert the data element, when the one data source has more than one data set, then displaying a list of available data sets.

18. The computer-readable medium of claim 17, further having computer-executable instructions for causing a computer to perform the steps comprising:
as the user interacts with the design surface to insert additional data elements, automatically assigning the additional data elements to a previously-utilized data source and a previously-utilized data set and then displaying a list of fields from the automatically assigned data set in the user-selectable field list.

19. The computer-readable medium of claim 17, wherein the user-selectable field list is displayed in a smart tag.

20. The computer-readable medium of claim 17, wherein the list of available data sources, the list of available data sets, and the option to create the new data source are displayed in a smart tag.
